(19) United States
(12) Patent Application Publication
(10) Pub. No.: US 2026/0213869 A1
(43) Pub. Date: Jul. 23, 2026

(54) Cooperative Jamming Transmission Method based on Transmission Blockage in Millimeter Wave Vehicular Network

(71) Applicant: XIDIAN University, Xi’an City, Shaanxi Province (CN)

(72) Inventors: Ying JU, Xi’an (CN); Mingjie YANG, Xi’an (CN); Suheng TIAN, Xi’an (CN); Lei LIU, Xi’an (CN); Qingqi PEI, Xi’an (CN)

(21) Appl. No.: 18/696,366

(22) PCT Filed: Apr. 19, 2023
(86) PCT No.: PCT/CN2023/089120

§ 371 Date: Apr. 6, 2026

(30) Foreign Application Priority Data
Nov. 24, 2022 (CN) 202211484362.3

(51) Int. Cl. H04K 3/00

(52) U.S. Cl. CPC H04K 3/43; H04K 3/80

(57) ABSTRACT

The present invention discloses a transmission method based on transmission blockage through cooperative interference in millimeter wave V2X network, and is related to the field of signal processing technology, which includes: construct a V2X network scenario; deploy an array antenna at the communication nodes of the V2X network scenario whose communication channel is a millimeter wave channel, model the millimeter wave channel, and obtain a millimeter wave blockage model; use a maximum average power association strategy to obtain the base stations connected to the legitimate receiving vehicles; obtain the idle users that meet a first condition based on the millimeter wave blockage model, and employ a stochastic process to obtain a first idle user set; obtain the idle users that meet a second condition in the first idle user set, and employ a stochastic process to obtain a second idle user set; obtain a theoretical expression of a security performance of the V2X network based on the millimeter wave blockage model, the first and the second idle user set, and evaluate a security performance of the V2X network. This application can improve the security performance of the network in a more efficient manner.

### FIELD OF INVENTION

The present invention relates to signal processing technology, in particularly related to a cooperative jamming transmission method based on transmission blockage in millimeter wave vehicular network.

### DESCRIPTION OF RELATED ARTS

V2X (Vehicle to Everything) is a key technology for future intelligent transportation systems, which enables vehicle-to-vehicle and vehicle-to-base station communications. Thus, a series of traffic information such as real-time traffic conditions, road information, and pedestrian information can be obtained to improve driving safety, mitigate congestion, enhance traffic efficiency, and provide in-car entertainment information, and etc.

In the existing technology, due to the high mobility of communication nodes in the V2X network, node locations may change frequently; and the network as a whole has strong time-varying characteristics, which brings communication link connections with extremely unstable problems. Usually, V2X network combined with cellular wireless access technology is able to solve the connection instability in the practical application of vehicular communications in the past, increase the capacity of communication channels, and improve the connection stability of communication links. In addition, the emergence of millimeter wave technology has promoted cellular vehicular network communications to a new stage. However, because the C-V2X network still lacks standardized security specifications or mechanisms, key confidential information transmitted in the network may be maliciously intercepted and eavesdropped, and may endanger human lives due to information leakage.

Therefore, there is an urgent need to improve the defects in the existing technology. When designing a C-V2X communication network, communication security should be given the highest priority and taken seriously.

### SUMMARY OF THE PRESENT INVENTION

In order to solve the above problems manifested in the existing technology, the present invention provides a cooperative jamming transmission method based on transmission blockage in millimeter wave vehicular network. The technical problems to be solved by the present invention are achieved through the following technical solutions:

First, this application provides a transmission method based on transmission blockage effect to design cooperative jamming in millimeter wave vehicular network, comprising:
constructing a V2X network scenario in which communication nodes of the V2X network scenario comprises legitimate receiving vehicles, eavesdropping vehicles, idle users and base stations;
deploying an array antenna having a communication channel at the communication nodes of the V2X network scenario, wherein the communication channel is millimeter wave channel between communication nodes, and modelling the millimeter wave channel, and obtaining a millimeter wave blockage model;
utilizing a maximum average power association strategy to obtain the base stations connected to the legitimate receiving vehicles;
obtaining the idle users that meet a first condition based on the millimeter wave blockage model, and employing a random process to obtain a first idle user set;
obtaining the idle users that meet a second condition in the first idle user set, and employing a random process to obtain a second idle user set; and
obtaining a theoretical expression of a security performance of the V2X network based on the millimeter wave blockage model and the second idle user set, and evaluating a security performance of the V2X network.

The advantageous effect of the present invention are:

The present invention provides a transmission method based on transmission blockage effect through cooperative jamming in millimeter wave vehicular networks, which processes scenario modeling of millimeter wave cellular V2X networks, which includes network node location distribution, antenna array model, and millimeter wave channel. Second, in view of the communication process of the present invention, which is the downlink communication process from the cellular base station to the legitimate associated vehicle, determine the association strategy of the base station, clarity which base station the vehicle is connected to; process theoretical improvement of the security performance of cellular V2X networks by using physical layer secure transmission scheme designed by stochastic geometric analysis, and provide a theoretical expression through theoretical derivation; wherein the physical layer security technology directly utilizes the random characteristics of the physical channel and does not rely on the complexity of the encryption algorithm. Compared with traditional key encryption technology, the security performance of the network can be improved in a more efficient way.

### BRIEF DESCRIPTION OF THE DRAWINGS

FIG. 1 is a flowchart illustrating a transmission method based on transmission blockage effect through cooperative jamming in millimeter wave vehicular network according to a preferred embodiment of the present invention.

FIG. 2 is a schematic diagram of a V2X network scenario according to the preferred embodiment of the present invention.

FIG. 3 is a schematic diagram illustrating how the security outage probability of a typical vehicle changes with the number of jammers according to the embodiment of the present invention.

FIG. 4 is a schematic diagram of the jammer selection scheme according to the embodiment of the present invention.

### DETAILED DESCRIPTION OF THE PREFERRED EMBODIMENT

The present invention is further described in details below with reference to specific preferred embodiments, but the embodiments of the present invention is not limited thereto.

In the existing technology, the following three types of solutions are usually adopted, which are theoretical analysis technology of communication performance in V2X networks; technology of utilizing cooperative jamming for secure transmission in planar networks; and network security technology based on key encryption. Wherein, taking into account that the theoretical research and analysis of vehicle communication needs to be based on the analysis framework of stochastic geometry, researchers have proposed some V2X network performance analysis technologies based on stochastic geometry. In addition, some researchers have modeled the spatial location of communication nodes in the vehicle network as a Cox process based on the Poisson line process, and then provided theoretical formula that can evaluate the coverage performance and security performance of the V2X network.

The above research mainly focuses on the innovation of theoretical analysis methods, and has not yet involved the design of secure transmission solutions in V2X networks. The main reasons are as follows: First, the unique location characteristics of vehicles bring computational complexity to theoretical analysis; vehicles are always distributed along streets, and the common two-dimensional Poisson point process is no longer suitable for modeling node location distribution restricted by roads in V2X networks. This has led researchers to devote their energy to the performance analysis of V2X networks. Second, the second type of related invention technology is mainly cooperative jamming transmission technology suitable for ordinary planar networks. The core of this type of technology is to design a jamming node screening scheme that meets the needs. The needs are mainly the network's requirements for security performance. Third, the protection of confidential information by network layer security technology based on key encryption is based on the complexity of the confidentiality algorithm. The longer the key and the more complex the encryption algorithm, the better the confidentiality of the information, resulting in a complicated process.

In summary, existing technologies have limited research on secure transmission issues in millimeter wave V2X networks. First, because the communication involving vehicles in the network is very sensitive to communication delay, especially the downlink transmission delay requirements are extremely high, the traditional network security key encryption technology is no longer the best choice for V2X networks. In addition, existing research on physical layer security technology in V2X networks mainly focuses on the security performance analysis of the entire network without using basic physical layer security technology or without any secure transmission design. However, the actual communication security in the vehicular network indirectly determines the personal safety of people in the network to a certain extent. Therefore, it is very important to research and design effective secure transmission solutions in the V2X network.

The existing technology has limited consideration of network communication reliability when designing a cooperative jamming node selection strategy. The improvement of transmission security performance is achieved at the expense of the reliability of target link transmission. In V2X networks, due to the high mobility of nodes, the probability of connection outage is higher than that of other static networks. Therefore, it is not advisable to endlessly trade connection performance for improved security performance, and may even lead to an extreme deterioration in the received signal-to-noise ratio of the target transmission link.

In view of this, the present invention uses physical layer cooperative jamming technology to propose a transmission method based on transmission blockage of millimeter wave Internet of Vehicles cooperative jamming to solve potential security threats in millimeter wave cellular V2X networks from the perspective of the physical layer. In addition, the present invention also uses the stochastic geometric analysis method to analyze and solve to obtain indicators representing the secure transmission performance of the communication system, theoretical expressions of security outage probability and security throughput, thereby achieving effective and reasonable prediction of system security performance.

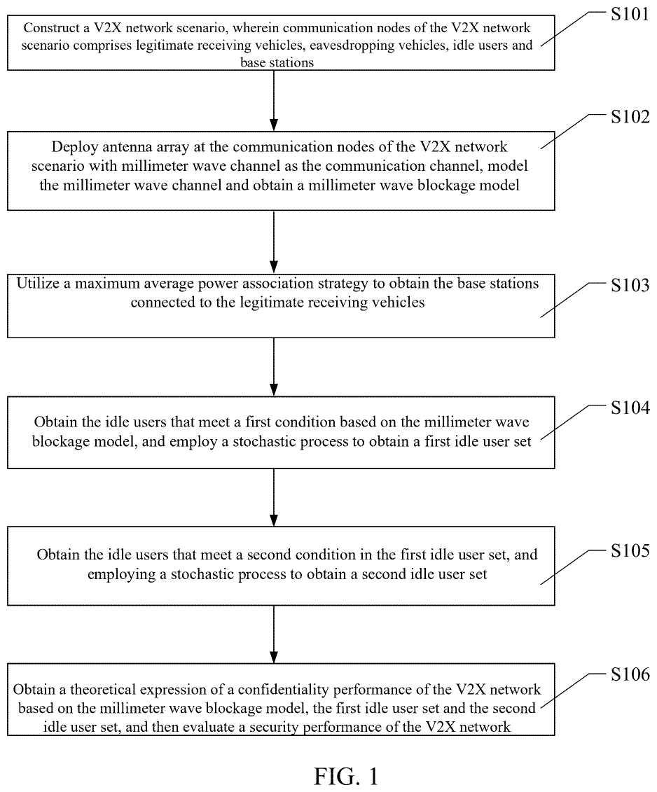

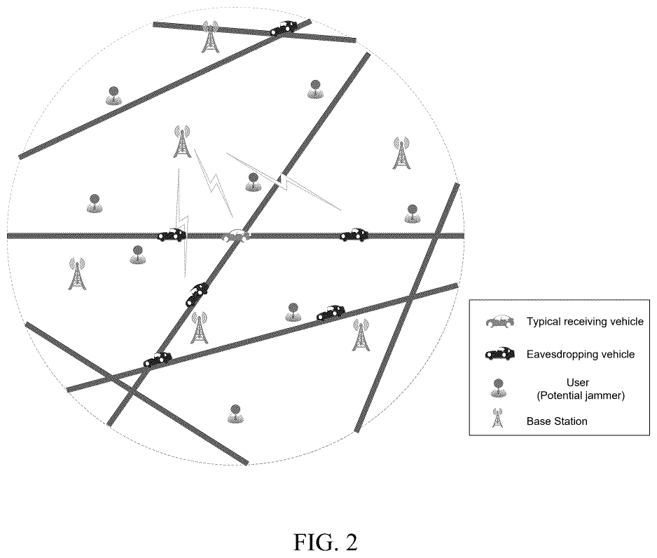

Referring to FIG. 1 and FIG. 2 of the drawings, FIG. 1 illustrates a flowchart for the transmission method based on transmission blockage of millimeter wave Internet of Vehicles cooperative jamming according to a preferred embodiment of the present invention, FIG. 2 illustrates a schematic diagram of a V2X network scenario according to the preferred embodiment of the present invention. The present application provides a transmission method based on transmission blockage through cooperative jamming in millimeter wave vehicular network, which comprises:
S101: construct a V2X network scenario, wherein communication nodes of the V2X network scenario comprises legitimate receiving vehicles, eavesdropping vehicles, idle users and base stations;
S102: deploy an antenna array at the communication nodes of the V2X network scenario in which the antenna array has a communication channel and the communication channel is millimeter wave channel, model the millimeter wave channel, and obtain a millimeter wave blockage model;
S103: utilize a maximum average power association strategy to obtain the base stations connected to the legitimate receiving vehicles;
S104: obtain the idle users that meet a first condition based on the millimeter wave blockage model, and employ a stochastic process to obtain a first idle user set;
S105: obtain the idle users that meet a second condition in the first idle user set, and employing a stochastic process to obtain a second idle user set, specifically, this is based on receiving power limit restriction;
S106: obtain a theoretical expression of a confidentiality performance of the V2X network based on the millimeter wave blockage model and the second idle user set, or based on the millimeter wave blockage model, the first idle user set and the second idle user set, and then evaluate a security performance of the V2X network.

Specifically, continue to refer to FIG. 1, which illustrates a transmission method based on transmission blockage through cooperative jamming in millimeter wave vehicular network. First, perform scenario modeling of the millimeter wave cellular V2X network, which includes location distribution of network nodes, antenna array model, and millimeter wave channel. Second, in view of the communication process of the present invention, which is the downlink communication process from the cellular base station to the legally associated vehicle, determine the association strategy of the base station, clarity which base station the vehicle is connected to; process theoretical improvement of the security performance of cellular V2X networks by using physical layer secure transmission scheme designed by stochastic geometric analysis, and provide a theoretical expression through theoretical derivation; wherein the physical layer security technology directly utilizes the random characteristics of the physical channel and does not rely on the complexity of the encryption algorithm. Compared with traditional key encryption technology, the security performance of the network can be improved in a more efficient way.

According to a selectable embodiment of the present invention, constructing the V2X network scenario comprises:
obtain a position of the legitimate receiving vehicle and use the position as the origin;
building a road model by using a line process Φ_{L} with a density λ_{L};
building a location distribution model of the eavesdropping vehicle on the Lₖ-th road by using a one-dimensional point process Ω_{L}_{ₖ} with density μₑ, where e is a specific location of the eavesdropping vehicle, e∈Ω_{L}_{ₖ};
building a location model of the base station by using a point process Φ_{B} with density λ_{B}, where b is the location of the base station, b∈Φ_{B};
building a location model of the idle users by using a point Φ_{U} process density λ_{U}, where uis the location of the idle user, u∈Φ_{U}.

Specifically, according to this embodiment, the constructed V2X network scenario includes a single legitimate receiving vehicle, multiple base stations, and multiple eavesdropping vehicles. The main communication process is: when an emergency occurs, the base station transmits confidential signals to the legitimate receiving vehicle through the downlink, and at the same time, the surrounding eavesdropping vehicles will passively eavesdrop on confidential signals, and idle users in the network will act as potential jammers to interfere with signals. In the process of constructing the V2X network scenario, the locations are limited to legitimate receiving vehicle, eavesdropping vehicles and idle users on the road. First, the Poisson line process is used to describe the randomly distributed locations of the road, and then one-dimensional Poisson points with the same density are used to process description of the legitimate receiving vehicle, the eavesdropping vehicles and the idle users. It is understandable that: obtain a position of the legitimate receiving vehicle and use the position as the origin; build a road model by using a line process Φ_{L} with a density λ_{L}; build a location distribution model of the eavesdropping vehicle on the Lₖ-th road by using a one-dimensional point process Ω_{L}_{ₖ} with density μₑ, where e is a specific location of the eavesdropping vehicle, e∈Ω_{L}_{ₖ}; build a location model of the base station by using a point process Φ_{B} with density λ_{B}, where b is the location of the base station, b∈Φ_{B}; build a location model of the idle users by using a point process Φ_{U} with density λ_{U}, wherein u is the location of the idle user, u∈Φ_{U}; therefore, the constructed V2X network scenario facilitates the formulation and theoretical analysis of jamming node selection strategies.

According to a selectable embodiment of the present invention, a gain of the array antenna is:

$${G}_{t , r} = \{ \begin{matrix}{M}^{2} & {Pr}_{{M}^{2}} = {( \frac{{θ}_{M}}{2 π} )}^{2} \\ Mm & {Pr}_{Mm} = \frac{{θ}_{M} ( 1 - {θ}_{M} )}{4 {π}^{2}} \\ {m}^{2} & {Pr}_{{m}^{2}} = {( \frac{1 - {θ}_{M}}{2 π} )}^{2}\end{matrix}$$

Wherein t is a signal transmitting end, r is a signal receiving end, M is the main lobe gain, m is the side lobe gain, θ is the main lobe width, Pr_{M}_{²} is a probability that a signal is emitted by the main lobe of the signal transmitting end and is received by using the signal receiving end of the main lobe.

Specifically, in this embodiment, array antennas are deployed at communication nodes in the V2X network scenario, and a sector model is used to approximate the gain effect produced by the antenna array. The gain of the array antenna obtained is:

$${G}_{t , r} = \{ \begin{matrix}{M}^{2} & {Pr}_{{M}^{2}} = {( \frac{{θ}_{M}}{2 π} )}^{2} \\ Mm & {Pr}_{Mm} = \frac{{θ}_{M} ( 1 - {θ}_{M} )}{4 {π}^{2}} \\ {m}^{2} & {Pr}_{{m}^{2}} = {( \frac{1 - {θ}_{M}}{2 π} )}^{2}\end{matrix}$$

Wherein t is a signal transmitting end, r is a signal receiving end, M is the main lobe gain, m is the side lobe gain, θ is the main lobe width, Pr_{M}_{²} is a probability that a signal is emitted by the main lobe of the signal transmitting end and is received by using the signal receiving end of the main lobe.

It should be noted that each base station can adjust its main lobe direction according to the position of the legitimate recipient vehicle to achieve perfect alignment with the receiving main lobe of the legitimate receiving vehicle; in addition, all communication nodes transmit signals with the same transmission power.

According to a selectable embodiment of the present invention, obtaining a blockage status of communication links between other communication nodes having different distances from the signal transmitting end based on the millimeter wave blockage model;
the communication links comprises a LOS link and a NLoS link;
wherein a probability that a communication link with a distance d from the signal transmitting end is the LoS link is p_{L}(d), and its expression is:

$${p}_{L} ( d ) = \{ \begin{matrix}{p}_{L} & d \leq D \\ 0 & d > D\end{matrix}$$

wherein p_{L} is a constant based on empirical values, p_{L}=0.2; D is a radius of a LoS sphere;
a probability that a communication link with a distance d from the signal transmitting end is the NLoS link is p_{N}(d), and its expression is:

$${p}_{N} ( d ) = 1 - {p}_{L} ( d ) .$$

Specifically, according to this embodiment, since the communication channel of the array antenna is a millimeter-wave channel, and the millimeter-wave channel is easily affected by blockage, there are two situations of line-of-sight propagation (LoS) and non-line-of-sight propagation (NLoS) for communication between communication nodes are considered. Wherein the constructed millimeter wave blockage model is a blockage sphere model. The blockage sphere model is used to describe the blockage state of communication links between other communication nodes with different distances from the signal transmitting end. The probability that the communication link is a LOS link with a distance d from the signal transmitting end is p_{L}(d), and its expression is:

$${p}_{L} ( d ) = \{ \begin{matrix}{p}_{L} & d \leq D \\ 0 & d > D\end{matrix}$$

wherein p_{L} is a constant based on empirical values, p_{L}=0.2. D is a radius of a LoS sphere;
a probability that a communication link with a distance d from the signal transmitting end is the NLoS link is p_{N}(d), and its expression is:

$${p}_{N} ( d ) = 1 - {p}_{L} ( d ) .$$

It should be noted that, for simplicity, the parameters or variables related to the blockage state are all identified by the subscript i∈{L, N} where L and N identify the LoS link and NLoS link respectively.

According to a selectable embodiment of the present invention, a signal power received by the communication node at a distance d from the signal transmitting end t is:

$${P}_{t} {G}_{t , r} {h}_{i} {C}_{i} {d}_{t , r}^{- {α}_{i}} ;$$

wherein Pₜ is a transmitting power, hᵢ is a small-scale fading of s channel,

$${C}_{i} {d}_{t , d}^{- {α}_{i}}$$

is a propagation loss of s signal during propagation, i is a blockage state of s link, αᵢ is a loss index of the communication link related to the blockage state.

Specifically, according to this embodiment, the impact of millimeter wave blockage is mainly reflected in small-scale fading and path propagation loss is considered. In this embodiment, Nakagami-m fading is used to describe the fading environment experienced by the millimeter wave channel, and the channel gain is represented by an independent and identically distributed random variable hᵢ~Γ(Nᵢ, 1/Nᵢ). Due to the millimeter wave blockage effect, the propagation loss generated during signal propagation is represented by the path loss function

$${C}_{i} {d}_{t , d}^{- {α}_{i}} ,$$

where αᵢ is the loss index of the communication link related to the blockage state, Cᵢ=10^{-β}^{ᵢ}^{/10} is the path loss intercept, and the obtained signal power received by the communication node with a distance d from the signal transmitting end t is

$${P}_{t} {G}_{t , r} {h}_{i} {C}_{i} {d}_{t , r}^{- {α}_{i}} .$$

According to a selectable embodiment of the present invention, the base stations connected to a legitimate recipient vehicle are:

$${b}^{*} = arg {max}_{b ∈ {Φ}_{B}} {P}_{t} {G}_{b , o} {h}_{i} {C}_{i} {d}_{b , o}^{- {α}_{i}}$$

Wherein Pₜ is a transmitting power, G_{b,o} is obtained antenna gain,

$${C}_{i} {d}_{b , o}^{- {α}_{i}}$$

is a path loss, b is the location of the base station, o is the location of the legitimate receiving vehicle.

Specifically, according to this embodiment, in order to ensure that the signal quality received by the legitimate receiving vehicle is the best, the maximum average power access strategy is selected to select the base station to which the legitimate recipient vehicle is connected.

According to a selectable embodiment of the present invention, setting the base stations into a LOS link base station and a corresponding NLoS link base station based on the communication link blockage state between the base station and the legitimate receiving vehicle, that is, the point process Φ_{B} comprises

$${Φ}_{B}^{L} and {Φ}_{B}^{N} ;$$

obtaining a probability A_{N} that the legitimate receiving vehicle receives the corresponding NLoS link base station, and its expression is:

$${A}_{N} = {\int }_{0}^{\frac{{D}^{{α}_{L}}}{{P}_{t} χ {C}_{L}}} exp ( - {Λ}_{B}^{L} ( [ 0 , σ ] ) ) {f}_{{σ}_{N}^{*}} ( σ ) d σ \times [ 1 - exp ( - {Λ}_{B}^{L} ( [ 0 , \frac{{D}^{{α}_{L}}}{{P}_{f} χ {C}_{L}} ] ) ) ] + exp ( - {Λ}_{B}^{L} ( [ 0 , \frac{{D}^{{α}_{L}}}{{P}_{t} χ {C}_{L}} ] ) )$$

wherein χ is the antenna gain, χ∈{M², Mm, m²}, M is the main lobe gain, m is the side lobe gain, σ is a signal strength, C_{L} is a loss intercept of the LOS link, and α_{L} is a loss index of the LoS link;
obtaining a probability A_{L} that the legitimate receiving vehicle receives the corresponding LoS base station, and its expression is:

$${A}_{L} = 1 - {A}_{N} ;$$

obtaining a probability density

$${f}_{{σ}_{L}^{*}} ( σ )$$

of the signal strength σ received by the legitimate receiving vehicle from the corresponding LoS base station, and its expression is:

$${f}_{{σ}_{L}^{*}} ( σ ) = π {p}_{L} {{λ}_{B} ( {P}_{t} χ {C}_{L} )}^{2 / {α}_{L}} \frac{2 {σ}^{2 / {α}_{L} - 1}}{{α}_{L}} \times exp ( - π {p}_{L} {{λ}_{B} ( {P}_{t} χ {C}_{L} )}^{2 / {α}_{L}} )$$

obtaining a probability density

$${f}_{{σ}_{L}^{*}} ( σ )$$

of the signal strength σ received by the legitimate receiving vehicle from the corresponding NLoS base station, and its expression is:

$${f}_{{σ}_{N}^{*}} ( σ ) = [ {p}_{N} exp ( - π {p}_{N} {{λ}_{B} ( {P}_{t} χ {C}_{N} σ )}^{2 / {α}_{N}} ) I ( σ \leq \frac{{D}^{{α}_{N}}}{{P}_{t} χ {C}_{N}} ) + exp ( - {{πλ}_{B} ( {D}^{2} - ( {P}_{t} χ {C}_{N} σ ) )}^{2 / {α}_{N}} ) I ( σ > \frac{{D}^{{α}_{N}}}{{P}_{t} χ {C}_{N}} ) ] \times {{πλ}_{B} ( {P}_{t} χ {C}_{N} )}^{2 / {α}_{N}} \frac{2 {σ}^{2 / {α}_{N} - 1}}{{α}_{N}}$$

where p_{N} is the probability that the link is in the NLoS state when the link length is d≤D, C_{N} is a loss intercept of the NLoS link, and α_{N} is a loss index the NLoS link.

Specifically, according to this embodiment, classify the base stations into two types of stations that have a LoS link and a corresponding NLoS link with the legitimate receiving vehicle, and then divide the point process Φ_{B} into two sub-process comprises

$${Φ}_{B}^{L} and {Φ}_{B}^{N} ,$$

that is

$${Φ}_{B} = {Φ}_{B}^{L} + {Φ}_{B}^{N} ;$$

after determining the association strategy of the base stations, it is necessary to first find the probability of legitimate receiving vehicle access to the LoS base station and to the NLoS base station respectively in order to obtain the probability of legitimate receiving vehicle access to each base station.

According to a selectable embodiment of the present invention, the first condition is: the idle user whose communication link with the legitimate receiving vehicle is a NLoS link.

Specifically, according to this embodiment, idle users who meet the first condition are determined according to the screening principle. In view of the information of eavesdropping vehicles being generally unknown in real situations, when selecting nodes that can be used as cooperative jammers, instead of selecting nodes that can produce the maximum interference intensity to the eavesdropping vehicles from the perspective of the eavesdropping vehicles, it is more reasonable and more in line with the real situation to select nodes that may cause the smallest possible interference to the node of the legitimate receiving vehicle as the interference node from the perspective of the node of the legitimate receiving vehicle node. Judging from the propagation characteristics of millimeter waves, signals propagated through NLoS links will suffer greater strength loss. Based on this, it is necessary to select idle user nodes whose communication links with the legitimate receiving vehicle are NLoS.

From the above, the idle users that meet the first condition are obtained, and the first idle user set are obtained. The following method is used to obtain the location distribution of the first idle user set, specifically:

Taking the LoS circle domain with radius D as the boundary, the idle users located inside the circle are two-dimensional Poisson point process

$${Φ}_{B , I}^{N}$$

with density p_{N}λ_{B}; the idle users located outside the circle are Poisson point process Φ_{B,O} with density λ_{B}, that is,

$${Φ}_{B}^{N} = {Φ}_{B , I}^{N} + {Φ}_{B , O} .$$

According to a selectable embodiment of the present invention, the second condition is: the idle user having a signal transmitted from the idle user to the legitimate receiving vehicle with a signal strength less than a strength threshold τ, that is:

$${P}_{t} {G}_{u , 0} {h}_{N} {C}_{N} {d}_{u , 0}^{- {α}_{N}} < τ ;$$

Wherein h_{N} is the small-scale fading of the NLoS link channel.

Specifically, according to this embodiment, the second condition is used to filter out the second idle user set from the first idle user set. It can be understood that in addition to requiring the link to the legitimate recipient vehicle to be NLoS, it is also necessary to limit the signal strength that these potential jamming nodes may generate to the legitimate receiving vehicle. The maximum interference intensity that the legal receiving vehicle can withstand is defined as τ, then the second filtering condition is: the signal strength transmitted by the node that can be used as an interference node to the legitimate recipient vehicle must be less than the intensity threshold τ, then the second condition is: the signal strength transmitted by the node that can be used as an interfering node to the legitimate recipient vehicle must be less than the intensity threshold τ, that is:

$${P}_{t} {G}_{u , 0} {h}_{N} {C}_{N} {d}_{u , 0}^{- {α}_{N}} < τ$$

From a physical sense, the selectable cooperative jamming node needs to meet the second condition of:

$${( \frac{{P}_{t} {G}_{u , 0} {h}_{N} {C}_{N}}{τ} )}^{1 / {α}_{N}} < {d}_{u , o} ; set {( \frac{{P}_{t} {G}_{u , 0} {h}_{N} {C}_{N}}{τ} )}^{1 / {α}_{N}} = B ;$$

Wherein B is the power limitation radius, and the final filtering result is expressed as

$${Φ}_{J} = {Φ}_{B}^{N} ∩ {b}^{c} ( o , B ) ,$$

where b^{c}(o, B) is the complementary space of a circle with o as the center and B as the radius; the location distribution of the final selected jamming nodes (jammers) is Φ_{J}.

According to a selectable embodiment of the present invention, the theoretical expression of the security performance of V2X network is:

$${p}_{s o} = 1 - P [ {\prod }_{e ∈ {Φ}_{E}} {SIR}_{b , e} \leq {β}_{e} ] ;$$

Wherein βₑ is a signal-to-interference ratio threshold that causes the security outage event to occur, B is a radius of the restriction area in the selection of jammers, and τ is a maximum interference power intensity that the legitimate receiving vehicle can tolerate, which is a threshold related to received power. When the signal-to-interference ratio at any eavesdropping node exceeds this threshold, a security outage event is considered to have occurred.

Specifically, according to this embodiment, in order to analyze the security performance of cellular V2X network under the designed cooperative jamming secure transmission scheme, it is necessary to obtain the theoretical expression of the security performance of V2X network:

$${p}_{s o} = 1 - P [ {\prod }_{e ∈ {Φ}_{E}} {SIR}_{b , e} \leq {β}_{e} ] ;$$

Wherein SIR_{b,e} represents the signal-to-interference ratio of the eavesdropping node located at e;
According to the millimeter wave blockage model, Φ_{E} is decomposed into three parts:

$$[ {E}_{{Ω}_{{L}_{k}}^{i , χ}} [ {\prod }_{e ∈ {Ω}_{{L}_{k}}^{I , χ}} P [ {SIR}_{b , e}^{i , χ} \leq {β}_{e} ] \vert {L}_{k} ∈ {Φ}_{L}^{I} ] ] \times {E}_{{Φ}_{L}^{I}} [ {E}_{{Ω}_{{L}_{k}}^{N , χ}} [ {\prod }_{e ∈ {Ω}_{{L}_{k}}^{I , χ}} P [ {SIR}_{b , e}^{N , χ} \leq {β}_{e} ] \vert {L}_{k} ∈ {Φ}_{L}^{I} ] ] \times {\prod }_{χ} {E}_{{Φ}_{L}^{O}} [ {E}_{{Ω}_{{L}_{k}}^{χ}} [ {\prod }_{e ∈ {Ω}_{{L}_{k}}^{χ}} P [ {SIR}_{b , e}^{χ} \leq {β}_{e} ] \vert {L}_{k} ∈ {Φ}_{L}^{O} ] ]$$

Since the signal-to-interference ratio can be expanded and written as:

$${SIR}_{b , e}^{i , χ} \leq \frac{{P}_{t} χ {h}_{b , e} {C}_{i} {d}_{b , e}^{- {α}_{i}}}{{I}_{e}^{J}} ;$$

substitute into it and it is expected to obtain the solution of the random variable in it, where the Laplace transform is:

$${L}_{{Φ}_{J}^{e}} ( s , {d}_{b , e} ) = {\prod }_{χ} q ( χ ) [ \sum {\int }^{\frac{{D}^{{α}_{L}}}{{P}_{t} χ {C}_{L}}} {\int }_{\vert {r}_{i} - {d}_{b , e} \vert}^{\vert {r}_{i} + {d}_{b , e} \vert} {A}_{i} {L}_{{I}_{{Φ}_{J}}} ( s , σ , v ) {h}_{i} ( v ) dvd σ + {\sum }_{i} {\int }_{\frac{{D}^{α} L}{{P}_{t} χ {C}_{L}}}^{∞} {\int }_{\vert {r}_{N} - {d}_{b , e} \vert}^{{r}_{N} + {d}_{b , e}} ( s , σ , v ) {h}_{N} ( v ) dvd σ ]$$

$${L}_{{I}_{{Φ}_{J}}} ( s , σ , {r}_{e} ) = {\sum }_{j} [ {\prod }_{i , χ} {L}_{{Ψ}_{j , I}^{i , χ}} ( s , σ , {r}_{e} ) {\prod }_{χ} {L}_{{Ψ}_{j , O}^{e}} ( s , σ , {r}_{e} ) ] ;$$

$${L}_{{I}_{{Ψ}_{j , I}^{i , χ}}^{e}} ( s , σ , {r}_{e} ) = exp ( - 2 π {p}_{i} q ( χ ) {\tilde{λ}}_{f} {\underbrace{{\int }_{{Ξ}_{I}^{{R}_{hj}}} {Q}_{i} ( s , χ , r ) rdr}}_{{A}_{1}} ) ;$$

$${L}_{{I}_{{Ψ}_{j , O}^{χ}}^{e}} ( s , σ , {r}_{e} ) = exp ( - 2 π q ( χ ) {\tilde{λ}}_{j} {\underbrace{{\int }_{{Ξ}_{O}^{{R}_{hj}}} {Q}_{N} ( s , χ , r ) rdr}}_{{A}_{2}} ) ;$$

according to the size relationship between the LoS circle radius D and the power limit radius B, A₁ and A₂ have different values:

$${A}_{1} = {\int }_{{E}_{1} ( v )}^{D} {Q}_{i} ( s , χ , r ) rdr - {\int }_{{E}_{2} ( v )}^{D} {Q}_{i} ( s , χ , r ) {θ}_{{R}_{hj}} ( r ) rdr ;$$

$${A}_{2} = {\int }_{D}^{∞} {Q}_{N} ( s , χ , r ) rdr - {\int }_{{E}_{3} ( v )}^{{r}_{e} + {R}_{hj}} {Q}_{N} ( s , χ , r ) {θ}_{{R}_{hj}} ( r ) rdr ; where$$

$${E}_{1} ( v ) = min \{ D , max \{ {R}_{hj} - v , D \} \}$$

$${E}_{2} ( v ) = min \{ D , max \{ {R}_{hj} - v , v - {R}_{hj} \} \}$$

$${E}_{3} ( v ) = max \{ D , v - {R}_{hj} \}$$

Through the above process, the confidentiality performance of the V2X network can be evaluated.

According to a selectable embodiment of the present invention, set the transmit power and shared antenna parameters as Pₜ=30 dBm, set the main lobe and side lobe gains as M=10 dB and m=−10 dB respectively, and the corresponding main lobe width is

$$θ = \frac{π}{6} .$$

The blockage related parameters are set as follows: α_{L}=2, α_{N}=2.92, N_{L}=3, N_{N}=2, β_{L}=61.4, β_{N}=72; the radius of the LoS ball is set as D=100 m.

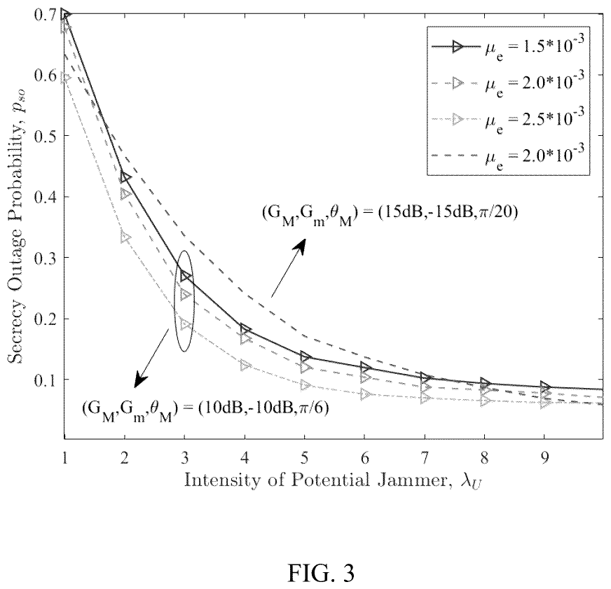

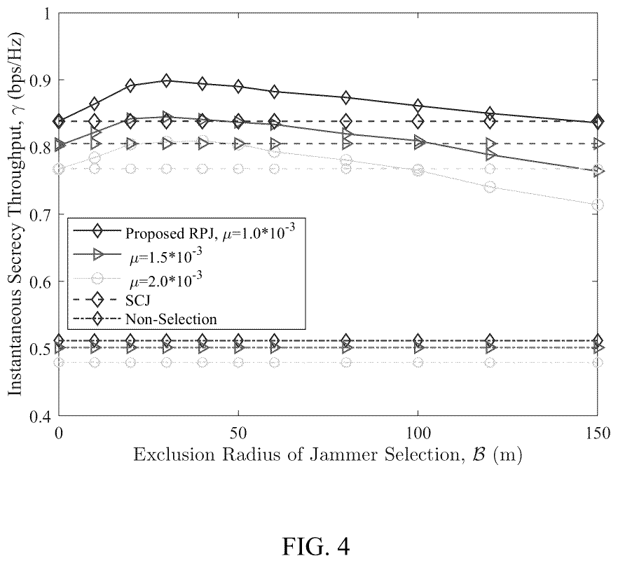

Referring to FIG. 3 and FIG. 4 of the drawings, FIG. 3 is a schematic diagram of the change of the security outage probability of a typical vehicle with the number of jammers provided by an embodiment of the present invention. FIG. 4 is a jammer selection scheme provided by an embodiment of the present invention. As shown in FIG. 2 of the drawings, as more jammers participate in the transmission process, the security outage probability decreases significantly. Compared with the number of eavesdroppers, the impact of eavesdropping can be reduced by using relatively few jammers, as shown by the line with triangles. In addition, it is not difficult to find that the narrower the beam of the jammer, the less likely it is that the eavesdropper will be covered, resulting in the smaller the inhibitory effect of the jammer on the eavesdropper. As shown in FIG. 3 of the drawings, the performance comparison of the RPJ strategy provided by this embodiment, the existing SCJ scheme, and the “no selection” strategy that does not make any selection is carried out. The overall performance of the three schemes is characterized by confidentiality throughput. Under the optimal power limit radius that maximizes confidentiality throughput, the RPJ scheme proposed in this embodiment is always better than the SCJ scheme. Both RPJ and SCJ are better than the “no selection” solution. The RPJ scheme will mitigate the impact of interference on legitimate receivers because RPJ imposes strict limits on the power of potentially interfering signals received by legitimate receivers. Furthermore, this drawing figure also shows that as the number of eavesdroppers increases, more jammers are needed to suppress interception.

What is claimed is:

1. A transmission method based on transmission blockage through cooperative jamming in millimeter wave vehicular network, characterized in that, comprising:
constructing a V2X network scenario, wherein communication nodes of said V2X network scenario comprises legitimate receiving vehicles, eavesdropping vehicles, idle users and base stations;
deploying an array antenna at the communication nodes in the V2X network scenario, where the communication channel millimeter wave channel, modelling the millimeter wave channel, and obtaining a millimeter wave blockage model;
utilizing a maximum average power association strategy to obtain the base stations connected to the legitimate receiving vehicles;
obtaining the idle users that meet a first condition based on the millimeter wave blockage model, and employing a stochastic process to obtain a first idle user set;
obtaining the idle users that meet a second condition in the first idle user set, and employing a stochastic process to obtain a second idle user set; and
obtaining a theoretical expression of a security performance of the V2X network based on the millimeter wave blockage model and the second idle user set, and evaluating a security performance of the V2X network.

2. The transmission method based on transmission blockage through cooperative jamming in millimeter wave vehicular network according to claim 1, characterized in that, idle users that meet the second condition is selected from the first idle user set based on s received power restriction condition, and a random process is used to obtain the second idle user set; and the theoretical expression of the security performance of the V2X network is based on the millimeter wave blockage model, the first idle user set and the second idle user set for evaluating the security performance of the V2X network.

3. The transmission method based on transmission blockage through cooperative jamming in millimeter wave vehicular network according to claim 1 or claim 2, characterized in that, constructing the V2X network scenario comprises:
obtain a position of the legitimate receiving vehicle and use the position as the origin;
building a road model by using a line process Φ_{L} with a density λ_{L};
building a location distribution model of the eavesdropping vehicle on the Lₖ-th road by using a one-dimensional point process Ω_{L}_{ₖ} with density μₑ, where e is a specific location of the eavesdropping vehicle, e∈Ω_{L}_{ₖ};
building a location model of the base station by using a point process Φ_{B} with density λ_{B}, where b is the location of the base station, b∈Φ_{B};
building a location model of the idle user by using a point process Φ_{U} with density λ_{U}, where u is the location of the idle user, u∈Φ_{U}.

4. The transmission method based on transmission blockage through cooperative jamming in millimeter wave vehicular network according to claim 1 or claim 2, characterized in that, wherein a gain of the array antenna is:
$${G}_{t , r} = \{ \begin{matrix}{M}^{2} & {Pr}_{{M}^{2}} = {( \frac{{θ}_{M}}{2 π} )}^{2} \\ Mm & {Pr}_{Mm} = \frac{{θ}_{M} ( 1 - {θ}_{M} )}{4 {π}^{2}} \\ {m}^{2} & {Pr}_{{m}^{2}} = {( \frac{1 - {θ}_{M}}{2 π} )}^{2}\end{matrix}$$
where t is a signal transmitting end, r is a signal receiving end, M is the main lobe gain, m is the side lobe gain, θ is the main lobe width, Pr_{M}_{²} is a probability that a signal is emitted by the main lobe of the signal transmitting end and is received by using the signal receiving end of the main lobe.

5. The transmission method based on transmission blockage through cooperative jamming in millimeter wave vehicular network according to claim 1 or claim 2, characterized in that, obtaining a blockage status of communication links between other communication nodes having different distances from the signal transmitting end based on the millimeter wave blockage model;
the communication links comprises a LOS link and a NLoS link;
where a probability that a communication link with a distance d from the signal transmitting end is the LoS link is p_{L}(d), and its expression is:
$${p}_{L} ( d ) = \{ \begin{matrix}{p}_{L} & d \leq D \\ 0 & d > D\end{matrix}$$
where p_{L} is a constant based on empirical values, p_{L}=0.2; D is a radius of a LoS sphere;
where a probability that a communication link with a distance d from the signal transmitting end is the NLoS link is p_{N}(d), and its expression is:
$${p}_{N} ( d ) = 1 - {p}_{L} ( d ) .$$

6. The transmission method based on transmission blockage through cooperative jamming in millimeter wave vehicular network according to claim 5, characterized in that, a signal power received by the communication node at a distance d from the signal transmitting end t is:
$${P}_{t} {G}_{t , r} {h}_{i} {C}_{i} {d}_{t , r}^{- {α}_{i}} ;$$
Where Pₜ is a transmitting power, hᵢ is a small-scale fading of s channel,
$${C}_{i} {d}_{t , d}^{- {α}_{i}}$$
is a propagation loss of s signal during propagation, i is a blockage state of s link, αᵢ is a loss index of the communication link related to the blockage state.

7. The transmission method based on transmission blockage through cooperative jamming in millimeter wave vehicular network according to claim 1 or claim 2, characterized in that, the location of the base station connected to the legitimate receiving vehicle is:
$${b}^{*} = {arg max}_{b ∈ {Φ}_{B}} {P}_{t} {G}_{b , o} {h}_{i} {C}_{i} {d}_{b , o}^{- {α}_{i}} ;$$
where Pₜ is a transmitting power, G_{b,o} is the obtained antenna gain,
$${C}_{i} {d}_{b , o}^{- {α}_{i}}$$
is a path loss, b is the location of the base station, o is the location of the legitimate receiving vehicle.

8. The transmission method based on transmission blockage through cooperative jamming in millimeter wave vehicular network according to claim 7, characterized in that, classifying the base stations into a LOS link base station and a corresponding NLoS link base station based on the communication link blockage state between the base station and the legitimate receiving vehicle, that is, the point process Φ_{B} comprises
$${Φ}_{B}^{L} and {Φ}_{B}^{N} ;$$
obtaining a probability A_{N} that the legitimate receiving vehicle receives the corresponding NLoS link base station, and its expression is:
$${A}_{N} = {\int }_{0}^{\frac{{D}^{{α}_{L}}}{{P}_{t} {χC}_{L}}} exp ( - {Λ}_{B}^{L} ( [ 0 , σ ] ) ) {f}_{{σ}_{N}^{*}} ( σ ) d σ \times [ 1 - exp ( - {Λ}_{B}^{L} ( [ 0 , \frac{{D}^{{α}_{L}}}{{P}_{t} χ {C}_{L}} ] ) ) ] + exp ( - {Λ}_{B}^{L} ( [ 0 , \frac{{D}^{{α}_{L}}}{{P}_{t} χ {C}_{L}} ] ) )$$
where χ is the antenna gain, χ∈{M², Mm, m²}, M is the main lobe gain, m is the side lobe gain, σ is a signal strength, C_{L} is a loss intercept of the LOS link, and α_{L} is a loss index of the LoS link;
obtaining a probability A_{L} that the legitimate vehicle receives the corresponding LoS base station, and its expression is:
$${A}_{L} = 1 - {A}_{N}$$
obtaining a probability density
$${f}_{{σ}_{L}^{*}} ( σ )$$
of the signal strength σ received by the legitimate receiving vehicle from the corresponding LoS base station, and its expression is:
$${f}_{{σ}_{L}^{*}} ( σ ) = π {p}_{L} {{λ}_{B} ( {P}_{t} χ {C}_{L} )}^{2 / {α}_{L}} \frac{2 {σ}^{2 / {α}_{L} - 1}}{{α}_{L}} \times exp ( - π {p}_{L} {{λ}_{B} ( {P}_{t} χ {C}_{L} )}^{2 / {α}_{L}} )$$
obtaining a probability density
$${f}_{{σ}_{N}^{*}} ( σ )$$
of the signal strength σ received by the legitimate receiving vehicle from the corresponding NLoS base station, and its expression is:
$${f}_{{σ}_{N}^{*}} ( σ ) = [ {p}_{N} exp ( - π {p}_{N} {{λ}_{B} ( {P}_{t} χ {C}_{N} σ )}^{2 / {α}_{N}} ) I ( σ \leq \frac{{D}^{{α}_{N}}}{{P}_{t} χ {C}_{N}} ) + exp ( - {{πλ}_{B} ( {D}^{2} - ( {P}_{t} χ {C}_{N} σ ) )}^{2 / {α}_{N}} ) I ( σ > \frac{{D}^{{α}_{N}}}{{P}_{t} χ {C}_{N}} ) ] \times {{πλ}_{B} ( {P}_{t} χ {C}_{N} )}^{2 / {α}_{N}} \frac{2 {σ}^{2 / {α}_{N} - 1}}{{α}_{N}}$$
where p_{N} is the probability that the link is in the NLoS state when the link length is d≤D, C_{N} is a loss intercept of the NLoS link, and α_{N} is a loss index the NLoS link.

9. The transmission method based on transmission blockage through cooperative jamming in millimeter wave vehicular network according to claim 1, characterized in that, the first condition is: the idle user having a communication link with the legitimate receiving vehicle with a NLoS link.

10. The transmission method based on transmission blockage through cooperative jamming in millimeter wave vehicular network according to claim 1, characterized in that, the second condition is: the idle user having a signal strength transmitted by the idle user to the legitimate receiving vehicle less than a strength threshold τ, that is:
$${P}_{f} {G}_{u , o} {h}_{N} {C}_{N} {d}_{u , o}^{- {a}_{N}} < τ$$
where h_{N} is the small-scale fading of the NLoS link channel.

11. The transmission method based on transmission blockage through cooperative jamming in millimeter wave vehicular network according to claim 1, characterized in that, the theoretical expression of a security performance of the V2X network is:
$$\begin{matrix}{p}_{so} = 1 - P [ {\prod }_{e ∈ {Φ}_{E}} {SIR}_{b , e} \leq {β}_{e} ] ; \\ B = {( \frac{{P}_{t} {G}_{u , o} {h}_{N} {C}_{N}}{τ} )}^{1 / {α}_{N}} ;\end{matrix}$$
where βₑ is a signal-to-interference ratio threshold that causes the security outage event to occur, B is a radius of the restriction area in the selection of jamming nodes, and τ is a maximum interference power intensity that the legitimate receiving vehicle can tolerate.
